(19) United States
(12) Patent Application Publication
(10) Pub. No.: US 2019/0333133 A1
(43) Pub. Date: Oct. 31, 2019

(54) A HOME AUTOMATION AND CONCIERGE SYSTEM AND METHOD FOR A PHYSICAL COMMUNITY OR NEIGHBORHOOD

(71) Applicant: Devcore Group, Gatineau, CA (US)

(72) Inventor: Jean-Pierre Poulin, Gatineau (CA)

(21) Appl. No.: 15/738,972

(22) PCT Filed: Oct. 26, 2017
(86) PCT No.: PCT/CA2017/051275

§ 371 Date: Dec. 21, 2017

Related U.S. Application Data
(60) Provisional application No. 62/413,060, filed on Oct. 26, 2016.
(60) Provisional application No. 62/433,690, filed on Dec. 13, 2016.

(51) Int. Cl. G06Q 30/06; G06Q 10/08; G06Q 50/10; G05B 19/042

(52) U.S. Cl. CPC G06Q 30/0641; G06Q 10/0833; G05B 2219/2642; G05B 19/042; G06Q 50/10

(57) ABSTRACT

The present invention provides a home automation and concierge system and method for a community. A user may access an interface to control home systems and device or use the concierge service to purchase goods and services available for at home delivery.

### FIELD

The present invention pertains to the field of electronic home management and concierge services, and in particular to a home automation and concierge system and method for a physical community or neighborhood.

### BACKGROUND

Smart technologies and home wide wireless networks allow for the control of home systems and devices. The connection of home systems and devices to networks both facilitates centralizing of controls and the accessing of home controls remotely.

With increasingly hectic lifestyles the ability to shop at home for goods and services is increasingly popular. Historically, consumers search the internet for a particular product or service and are presented with a vast array of options with respect to vendors and specific products. Consumers must then either comb through the options or refine the search parameters. Reviewing product or service search results from an appropriate vendor can be time intensive. In addition to ensuring that the vendor can meet the consumers' needs in terms of product, service or selection, a consumer wishing to have the product or service at home must identify vendors which deliver or provide in-home services. In-home provision of products and services has generally been limited to fast food style restaurants or the on-line retailers that can use mail or courier services to deliver products.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a home automation and concierge system and methods for a physical community or neighborhood. In accordance with an aspect of the present invention, there is provided a home automation and concierge system comprising a home management system operatively connected to one or more devices; wherein the home management system is configured to receive input signals from said one or more devices, generate one or more device commands and transmit the one or more device commands to said one or more devices; a home concierge system configured to interact with a cloud-based concierge service and at least one user interface configured to allow a user to operate with the home management system and order from the home concierge system.

### BRIEF DESCRIPTION OF THE FIGURES

Embodiments of the present invention will be better understood in connection with the following Figure, in which:

FIG. 1 illustrates components of the system.

FIG. 2 illustrates one embodiment of the concierge interface.

FIG. 3 illustrates one embodiment of a restaurant category page for the concierge service.

FIG. 4 illustrates one embodiment of a health category page for the concierge service.

FIG. 5A to 5C illustrates vendor pages in the health category for the concierge service.

FIG. 6 illustrates vendor log in page.

FIG. 7 illustrates an exemplary vendor order page.

FIG. 8 illustrates an exemplary administrator log in page.

FIG. 9 illustrates an exemplary vendor management page.

FIG. 10 illustrates an exemplary page for setting up new accounts.

FIG. 11 illustrates a flow diagram of interactions between parties and elements of the consumer goods and/or services distribution system.

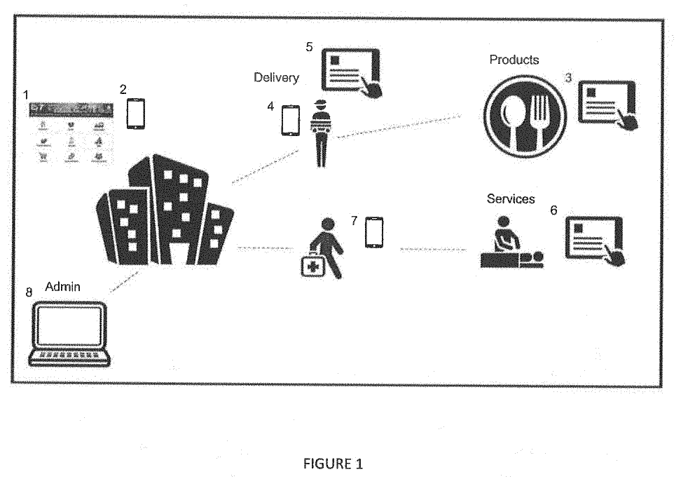

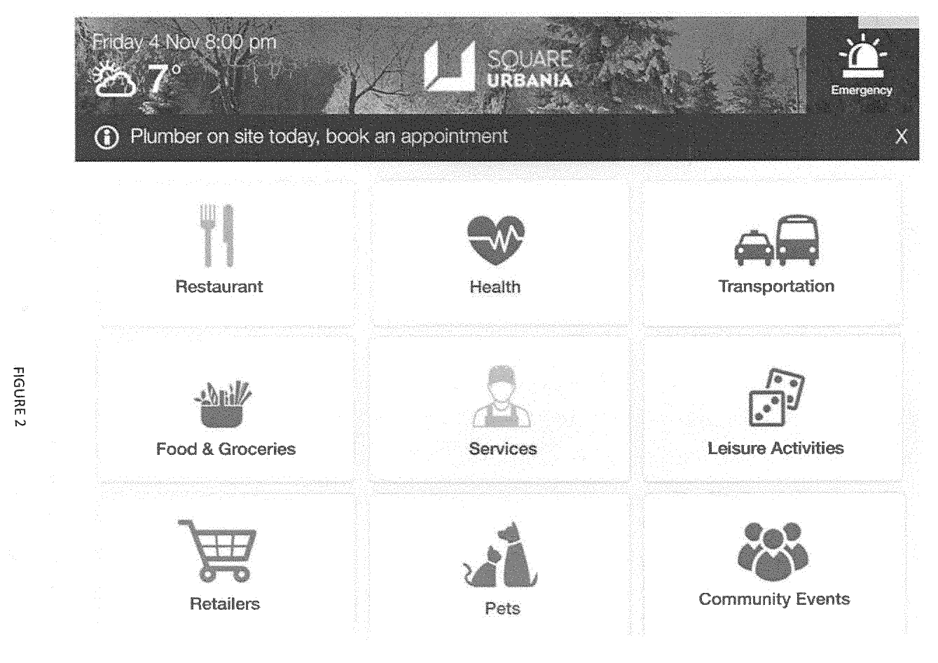

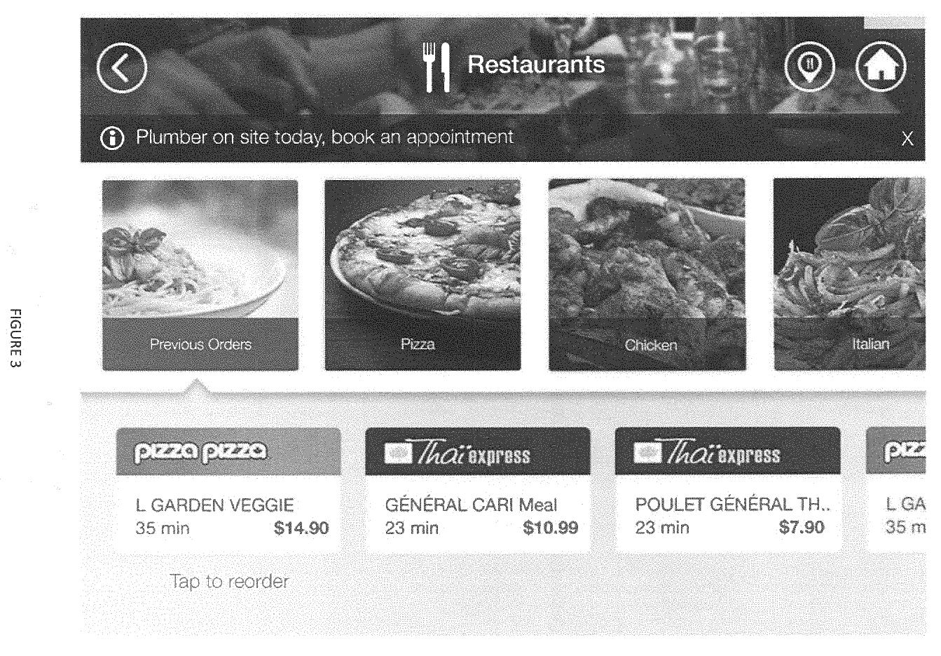

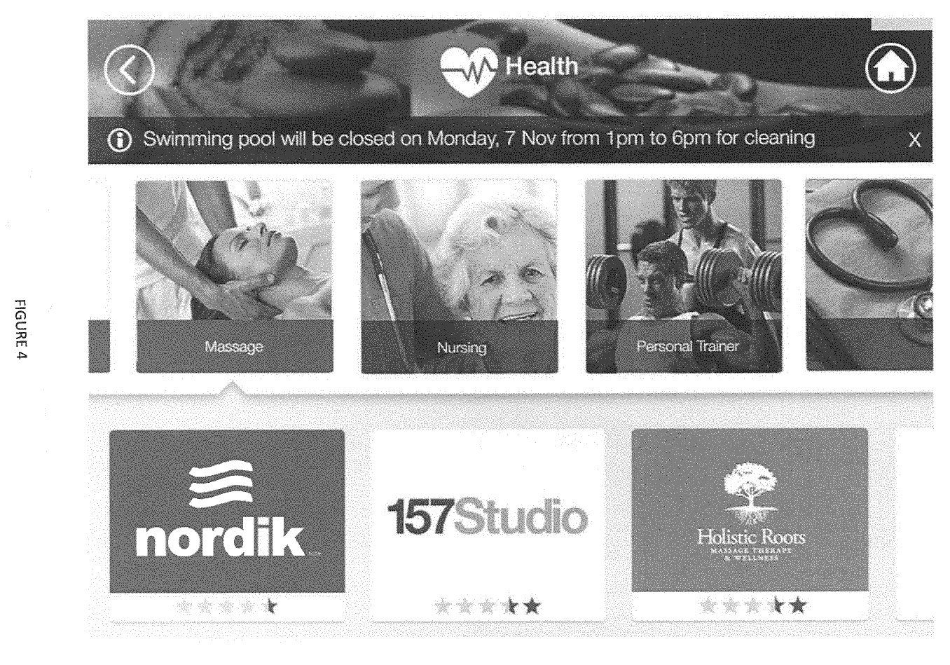

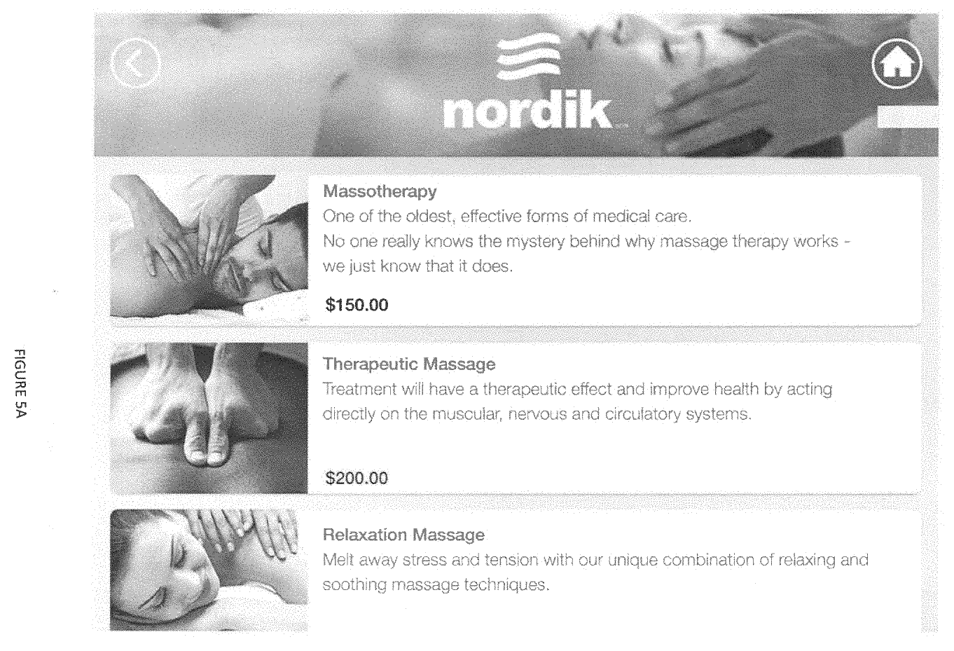

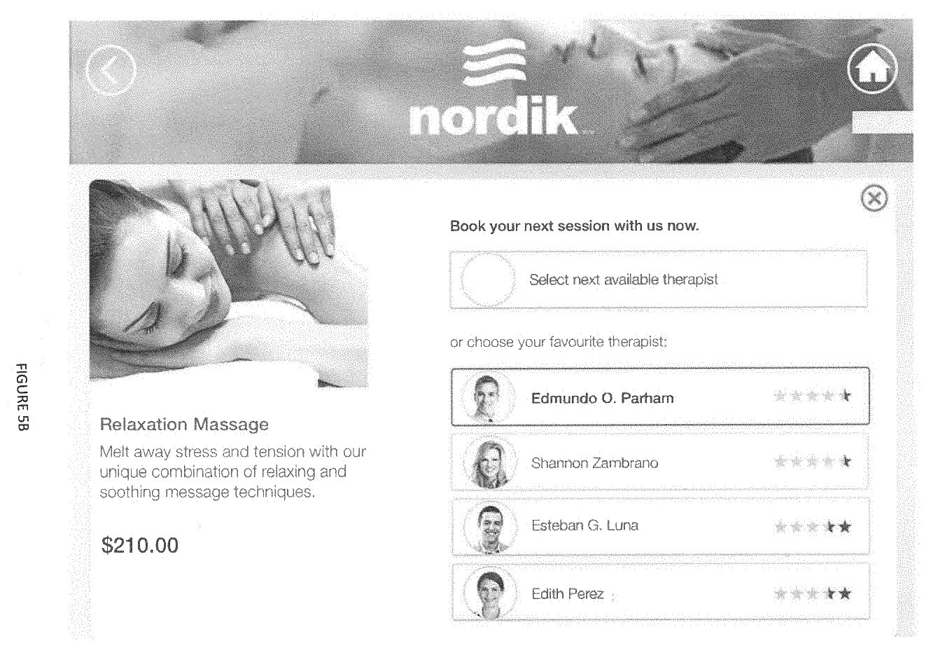

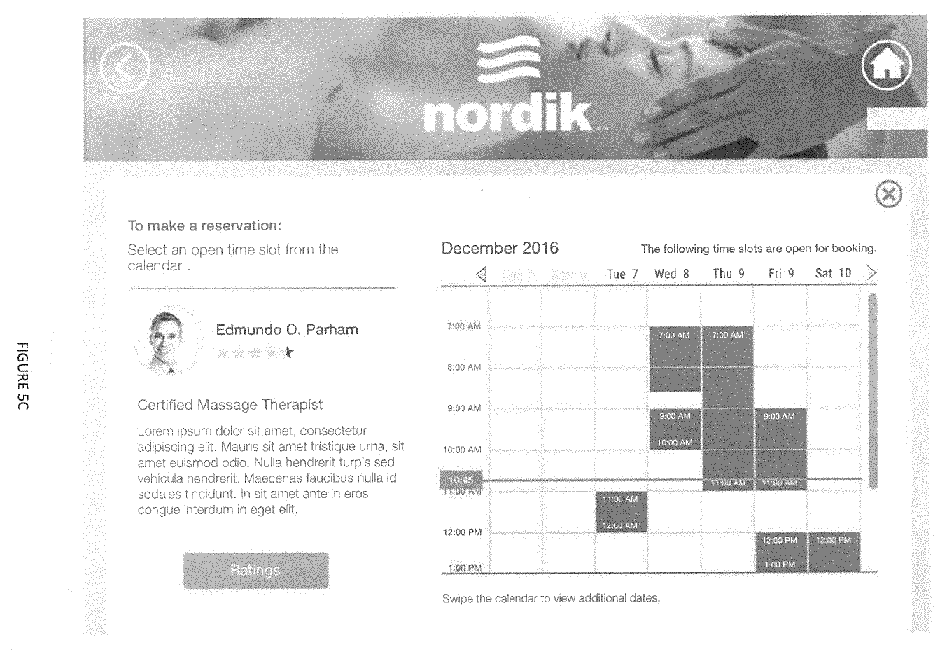

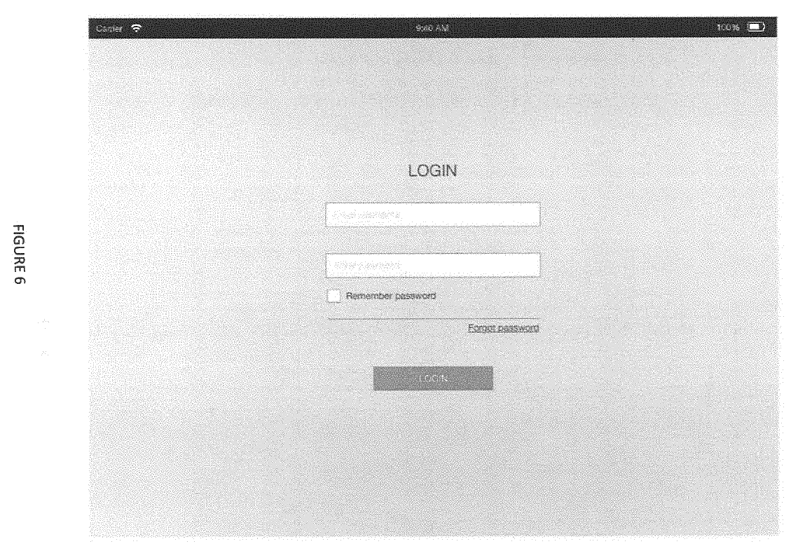

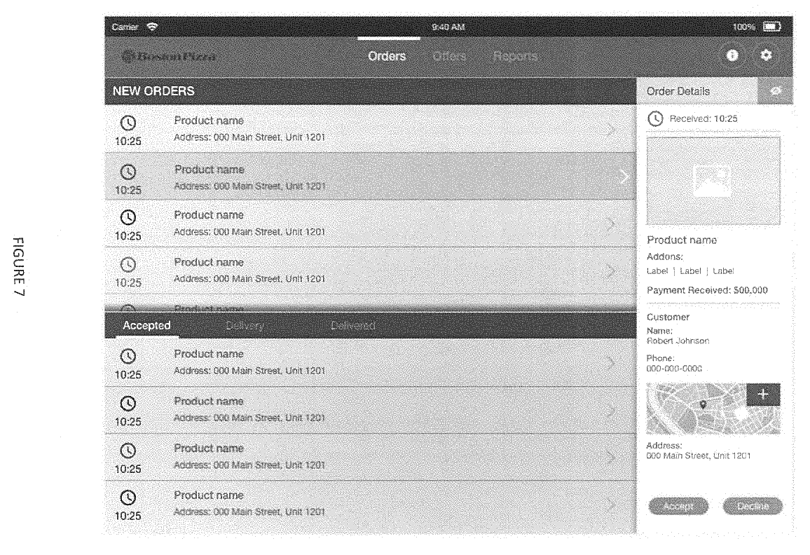

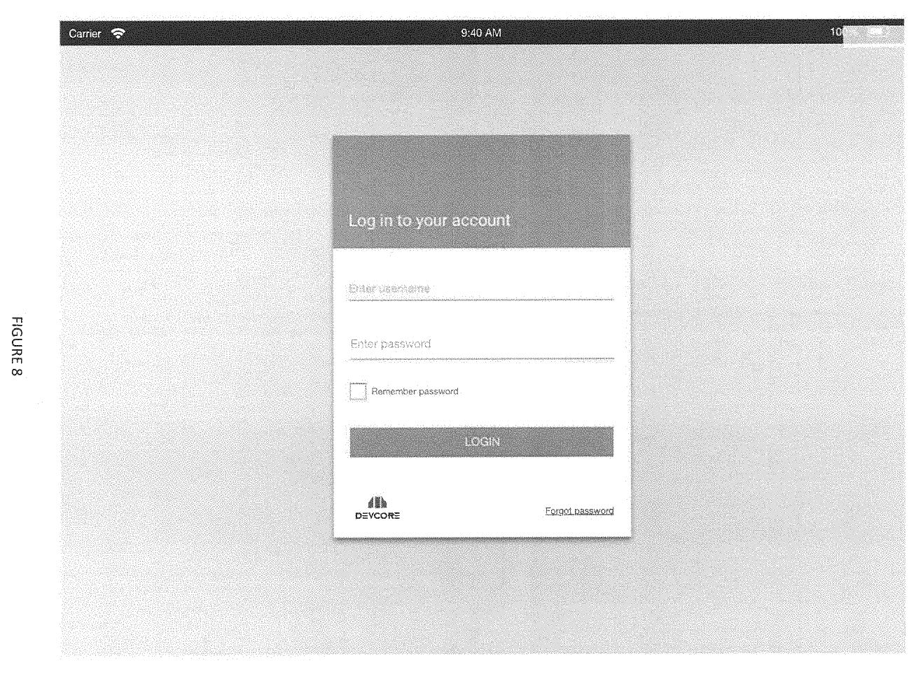

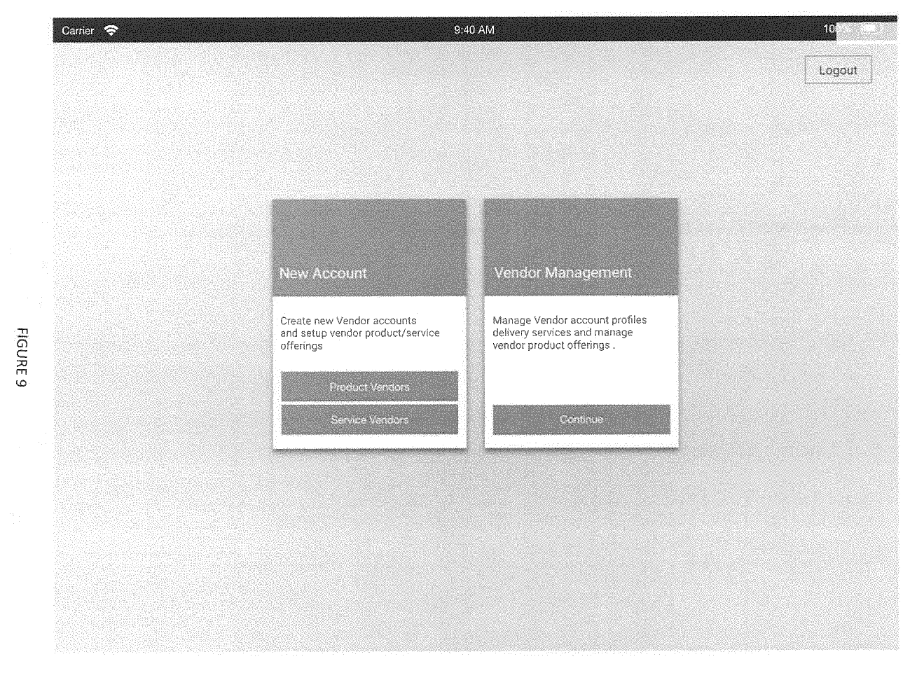

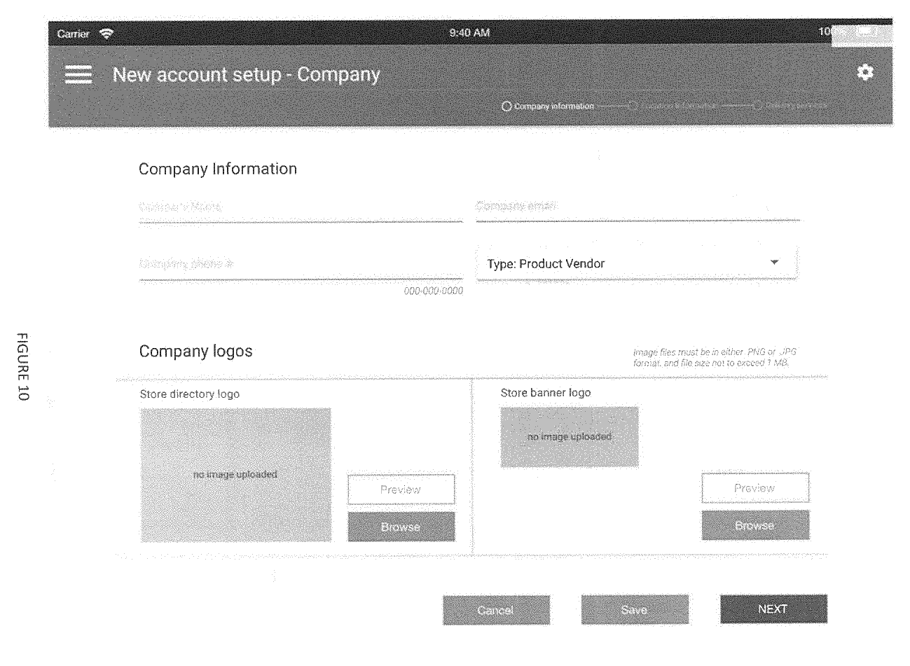

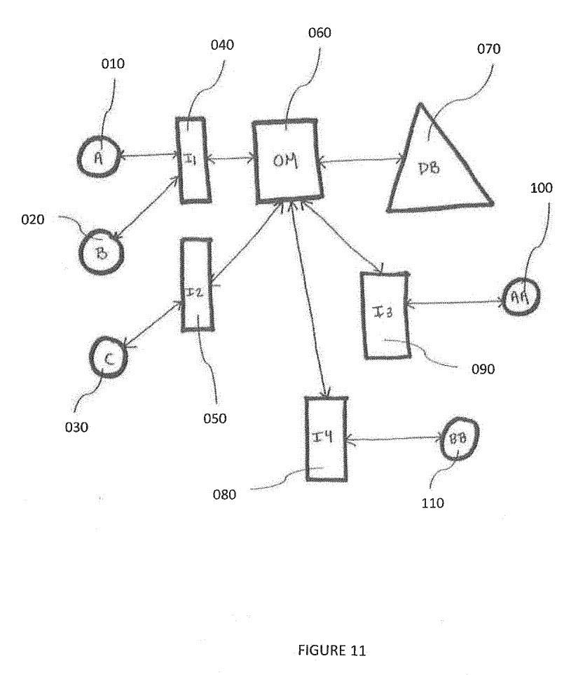

### DETAILED DESCRIPTION

### Overview

The invention provides systems and methods for home management and concierge services for a physical community or neighborhood. The systems and methods of the invention facilitate the development of physical community or neighborhood-based commerce by focusing consumer's attention to local retailers and service providers. Optionally, the systems and methods of the invention are configured to facilitate resident to resident (or landlord or condominium board) interactions and commerce such that a resident in a physical community or neighborhood capable of providing a service (for example, a plumber) can offer that service to another member of the community or neighborhood.

In some embodiments, the systems and methods are configured to facilitate peer-to-peer (P2P) commerce and transactions.

The systems and methods of the invention are optionally configured to be responsive to the changing needs of the neighborhood, for example, changing demographics as populations age.

In some embodiments, the invention is configured to provide simplified and intuitive home automation, home security and home concierge service. The system and method are modular and adaptable to the size, the configuration and the type of the community as well as community demographics. Physical communities include multi-unit dwellings, single home communities and mixed dwelling communities and may be defined by geographic boundaries or physical proximity. Multi-unit dwellings include townhomes, apartments including high rise apartments, flats, mix-use buildings, and apartment communities. For mixed dwelling or mixed use communities, the system and method may include residential, business and public modules. Public modules include modules specifically adapted to public spaces including for example community libraries, schools, places of worship, halls and other common areas, etc. In some embodiments, health modules are provided. Communities also include gated communities and those designed for specific demographics such as age-restricted communities including adult communities or senior communities. In such embodiments, modules specifically adapted to the specific demographic are optionally provided.

In some embodiments, mixed use communities may be configured to provide the majority of services used on a day-to-day basis by community members.

The systems and methods may be configured for rental properties, condominiums, co-operatives, leasehold or freehold or other. Fees for use of the service and method may be incorporated into rent or condominium fees or may be payable on a contract basis. In some embodiments, fees for the concierge service are payable by the vendor or the consumer optionally on a per transaction basis or on a subscription basis.

The system and method may be configurable for new builds, retrofits or renovations. In some embodiments, components of the system may be integrated into the dwelling or building structure and/or mounted thereon. The system may also include components remote from the dwellings or buildings including sensors, etc, for example, located in the grounds and/or around the dwellings or buildings of the community.

The system and method may be configured to interact with third party systems including tracking systems, monitoring systems and law enforcement and/or emergency services to provide enhanced or additional services.

In some embodiments, the system and method comprise a cloud-based software platform that integrates network-connected systems and devices including sensors to access or operate home automation and home concierge services. The system may be configured to allow for lock out or override of the home automation and/or home concierge service.

Optionally, the system and method is configured to allow for access and use of social media and preferably social media within the community context. Optionally, the system and method may be configured to include a community message board or calendar. In some embodiments, the system and method can be configured to send community wide alerts, including that there happens to be a product or service provider on site for the consumer's convenience, optionally alerts are sent to all users' mobile devices. In some embodiments, the system and method may be configured to include or interact with an emergency broadcast system.

In some embodiments, the home management system and concierge services is configured to interact with smart car systems to facilitate the management of car maintenance. In such embodiments, the concierge service includes car service providers that pick up and drop off cars at home.

The system and method are configured to provide a simplified, user-friendly home management and concierge service by connecting smart home systems with concierge services that are in some embodiments driven by user or consumer preferences. The control of the system and services can be pre-defined, user defined, administrator defined or a combination thereof. In some embodiments, the system and method provides for in-home control and/or access to home systems and/or services. In some embodiments, the system and method provides for remote control and/or access to home systems and/or services. In some embodiments, the system and method provides for both in-home and remote controls. Optionally, the accessibility to specific modules by in-home control, remote control or both can be set by a system administrator.

The system and method for home management and concierge service includes a user interface that allows a user to access home management systems and concierge services. The user interface may include an in-home application and optional mobile application.

In some embodiments, the home management system and concierge services interact with each other to facilitate the delivery of services and/products. For example, the home management system can be programmed to allow access to the home and their home monitoring and security systems for service and product providers to facilitate delivery of services and products. The system may be further configured to facilitate product or service provider tracking.

Optionally, the home management system and concierge services can be configured to send the user reminders regarding recurring appointments. For example, the home management system and concierge can be configured to send the user a reminder regarding the need to schedule a follow up massage appointment.

The system comprises an in-home interface or control panel to provide access to the home management and concierge systems. The in-home interface or control panel may be custom-made or a specifically programmed off-the shelf component. The in-home interface may comprise a tablet, a desktop computer, laptop computer, or the like. In some embodiments, the in-home interface comprises a wall-mounted tablet.

In some embodiments, the in-home interface or control panel is voice controlled.

The interface comprises a home page having a smart menu with a series or set of selectable options and optionally access to the smart menu is protected either by password, biometric scanning or other means known in the art.

In some embodiments, the interface may be configured to lock-out one or more of the services. For example, access to lighting controls may be available to everyone but access to concierge services may be limited to authorized users.

The invention may further comprise a mobile app that allows access to the home management system, the concierge system or both via portable electronic devices including handhelds such as tablets and smart phones, watches and glasses.

In one embodiment, the user of the consumer goods and/or services distribution system and method may be an individual, couple, group, group of individuals, family, roommates, or other entity living within a residential dwelling as would be understood by someone skilled in the art.

In a further embodiment, the user of the consumer goods and/or services distribution system and method may be an individual, couple, group, group of individuals, family, roommates, business, partnership, corporation, or otherwise as would be understood by someone skilled in the art.

In some embodiments, delivery tracking uses radio frequency transponder and remote reader units. In some embodiments, dwellings or buildings are equipped with appropriate equipment.

In some embodiments, the system uses GPS tracking technologies.

In some embodiments, the system uses geolocate IP address and geospatial data to provide access to dwellings or buildings.

In some embodiments, the system and methods use Wi-Fi based positioning systems or iBeacons.

### Home Management System

The home management system includes home security management and premise management system that includes environmental control management and entertainment management.

Home security management interfaces with home security and safety systems including alarms, security cameras, entry detection systems, fire alarms, sprinkler systems, motion or movement sensors, beacons, location detectors, fall detection and/or health monitoring systems. The system is configured to provide for arming security systems and optionally notifying emergency services in the event of an emergency.

In some embodiments, the home security system incorporates facial recognition, voice recognition or other technologies know in the art to allow for identification and/or tracking of individuals and/or objects.

In some embodiments, access to a premise can be provided based on facial recognition or other biometric features.

In some embodiments, the home security management interfaces with community security systems. In apartment or flat style communities, community security systems include public space security cameras, entry detection, motion detectors, and location detectors. The home security management interface, in some embodiments, is configured to allow residents to communicate and/or monitor public spaces and/or allow parties to access the building.

The premise management system provides for the control of home comfort systems including environmental controls such as heating, cooling, HVAC, air quality systems, venting, smart window coverings, lighting and illumination controls; home sensors and home entertainment systems including speakers, audio and visual systems, and internet access. The premise management system includes appropriate sensors and control elements as is known in the art.

The system is optionally configured to automatically adjust temperature, humidity and other environmental conditions in response to sensed conditions.

The home management system may optionally be configured to be accessed by a smart device app.

### Concierge Service

The concierge service is configured to simplify consumer choice by preselecting a set of preferred businesses or vendors, optionally the highest consumer rated or ranked businesses or vendors, to offer home services or products. Preferred businesses or vendors will generally be located within or proximal to the community thereby facilitating the development of a close-knit neighborhood. In some embodiments, preferred businesses or vendors will offer both service and products for delivery to a residence and a physical store front. Optionally, preferred business or vendors may offer users of the at-home concierge service preferred customer service or discount.

In some embodiments, residents of the community qualified to provide a specific service or product are included in the preferred businesses or vendors.

In some embodiments, the concierge service is configured to also facilitate peer-to-peer (P2P) commerce and transactions between residents of the community or neighborhood.

The concierge service includes a consumer interface accessible either through the system and method interface or directly by appropriate electronic devices known in the art.

The concierge service is accessible by smart menu with a series of selectable options. In some embodiments, the concierge service shows the top 3 or 4 highest rated or ranked providers of a specific product or service, or the top 3 or 4 ranked pizza restaurants that provide home-delivery. The concierge service can be personalized to show products and services most commonly accessed by the specific consumer up front.

The concierge service can be optimized using the 80-20 Rule such that in some embodiments the products and services offered by each vendor for the concierge service are the 20% of products or services that accounts for 80% of revenue (profit).

In some embodiments, the 80-20 Rule is used to cull vendors that are not maintaining pre-determined standards and replace them with other vendors. In particular, in some embodiments the system and method is configured to either on request or at pre-determined times identify the 20% of vendors which generate 80% of customer complaints for a specific product or service. Once identified, the system administrator can optionally assess the complaints raised against the individual vendors and determine if any further steps are necessary.

In some embodiments, the system and method may be configured to drop goods and/or service providers that have an average ranking or rating below a set point.

In one embodiment, the interface includes a home page or screen having a menu of options. In the illustrated embodiment, the menu includes a set of selectable icons with each icon representing a class or category of available at home services, products or activities including, for example, restaurant, health, transportation, food and groceries, services, leisure activities, retailers, pet services including animal grooming, veterinary services, dog walking and pet sitting, more, and emergency. In some embodiments, the concierge services can include services that require pick up, including car services, dry cleaning or laundry services, etc.

Once a class or category is selected a class or category home page opens and a page showing subclass or subcategories opens. Selection of a subclass or subcategory opens a page with vendor options.

Once a vendor is selected available products and services are listed.

Optionally, once a product or service is selected a new page opens that allows for modification of the product and/or scheduling of service or delivery.

In some embodiments, the system is configured for operation with third party applications or programs. For example, the system is configured to allow for the uploading of grocery lists, calendar or scheduling programs etc.

The system and method optionally provides for consumer feedback which can optionally be used to adjust vendor ranking.

In some embodiments, the consumer fills an easy survey that is used to rank the vendors. Optionally, the service and product providers are listed based on ranking. In some embodiments, ranking is adjusted regularly, at fixed intervals or in real time.

In some embodiments, the concierge platform adjusts to consumer's preferences and historical use and purchasing habits by presenting the highest ranked providers but also the most used based on usage. Optionally, it also adjusts based on persona, community and city's endorsement of the providers.

The present invention provides a home concierge service for products and/or services. Users of the concierge service access the service via an interface configured to allow the user to search, select, and order products and/or services from designated providers. The system monitors and optionally manages the orders for the products and/or services including monitoring order completion.

The home concierge service user interface is also configured to allow users to track delivery and service personnel.

In some embodiments, the home concierge service includes an at-home concierge application, an optional mobile concierge application, vendor applications including product and service applications, delivery application, platform administration and optional delivery service administration.

The concierge applications including the at-home and mobile application are configured to allow users to purchase products and services and track delivery of products and service personnel by interfacing with the delivery application.

The vendor applications including product and service applications that allow for the creation and/or updating of online menus or stores, receive and confirm orders and view all transactions. The service applications also provide for appointment scheduling or bookings. The system optionally includes service provider or delivery application modules that shows delivery information, provides directions, provides for tracking and optionally provides for an emergency button.

In some embodiments, the tracking provided by the vendor application is specifically configured to allow the system to track the delivery or service personnel and alert if the delivery or service is exceeding a pre-specified period of time. For example, a massage therapist may access the application and activate a timer for a 90 minute appointment. If the timer is not deactivated after 90 minute+specified window of time an alert is sent to the massage therapist and a designated contact indicating that the massage therapist is overdue. Optionally, the alert to the designated contact includes current location and time at location. This feature is intended to provide delivery and service personnel increased personal security.

The home concierge service is operatively associated with a database that stores information about the products and/or service providers. The database also includes details regarding user selections. Details regarding user selections can be used to update product and service selections. An operating module comprising a microprocessor operatively coupled to memory performs one or more operations involving the products and/or service providers, and the user selections and interactions with the system. Some of the operations performed by the operating module include monitoring the system interactions, analyzing selections made by the user, ranking the products and/or service providers, requesting products and/or services, confirming selections and distribution, managing the provision of products and/or services, uploading, downloading, and transferring information or payment.

The present invention also provides a method in which a consumer makes a selection related to products and/or services. The vendor after receiving notice of the order provides the selected product and/or service. The operating module coordinates the provision of product and/or services to the consumer. The operating module facilitates and confirms payment from the user to the products and/or service provider. The operating module then confirms the order has been submitted and accepted by the vendor. The operating module then provides selection tracking capabilities so that the consumer may track their product and/or service selection. Finally, the operating module will notify the consumer that the product and/or service has arrived for consumption or use.

The operating module also ranks the vendor based on the provision of products and/or services to the consumer. This ranking may influence the selection of products and/or services by displaying the products and/or service providers upon the user interface in a manner reflective of the ranking.

In some embodiments, the system and method may require the consumer to provide a ranking of or rate the goods and/or services upon receipt of the same. Optionally, the system and method may prevent further selections of goods and/or services until prior goods and/or services are ranked or rated.

In some embodiments, the consumer is provided a reward for completing a ranking or rating. Rewards may be points redeemable for additional goods and/or services.

Optionally, the ranking may be in the form of a star rating or letter grade. In some embodiments, the system is configured to provide an average ranking or rating based on consumer feedback. The ranking or rating is optionally multi-component and can include factors such as timeliness, goods and/or services quality, etc.

The operating module may also distribute payment for the goods and/or service to a number of entities such as but not limited to the vendor, and/or distributor.

In one embodiment, the vendors may be an individual, group, group of individuals, business, partnership, corporation or other entity able to provide a good and/or service to a user at the user residential dwelling.

In another embodiment, the vendors may provide a goods and/or service to a user at a location as determined by the user.

### System

In one embodiment, the user interface may be accessed within a residential dwelling. The user interface may be available on a touch screen mounted upon the wall of the residential dwelling. The touch screen may be removable. There may be more than one touch screen available within the residential dwelling.

In another embodiment, the user interface may be available online, accessed by using a personal communication device.

In one embodiment, the operating module will use and assess information stored within a database to objectively rank vendors. This ranking will influence the appearance of the vendor upon the user interface.

In another embodiment, the assessment of operating module will result in the display of the three highest ranked vendors upon the user interface. The user will be able to rely on the quality of goods and/or service provided by the vendor based on the display of the vendor upon the user interface. The vendors may be able to improve their ranking by objectively improving the quality of the goods and/or services offered. As the vendor ranking improves, they may overtake other vendors, which may allow them to be displayed upon the user interface. In this way the overall quality of goods and/or services offered to a user will continually improve.

In one embodiment, the operating module may request, confirm, distribute, and manage the provision of goods and/or services by facilitating communication and interaction between a user and a vendor. This communication and interaction may be facilitated through the touch screens as provided within a residential dwelling, and distributed to a vendor. The communication may also be facilitated through personal communication devices of the user and vendor.

In one embodiment, the transfer of payment between the user and the vendor may incur a transaction fee imposed as a lump sum, percentage of sale, or otherwise as would be understood by someone skilled in the art.

In one embodiment, payment may consist of the distribution of money, credits, funds, tokens, barter vouchers, or otherwise as would be understood by someone skilled in the art.

In one embodiment, a portion of the payment for goods and/or services may be redistributed.

In another embodiment, the redistribution of payment may result in the user receiving payment at a later time for having used the consumer goods and/or services distribution system. This redistribution payment may be provided by the vendor, another user, or the distributor.

In another embodiment, the redistribution payment received to a user by a vendor may be as a direct result of the user requesting goods and/or services from that vendor. The vendor may allocate funds previously delegated for another purpose to make up this distribution payment. For example, a vendor may reassign some funding previously allocated to advertising or marketing their goods and/or services. This advertising or marketing funding may then be passed onto a user who selects their goods and/or service as user incentive. This may improve the ability for a vendor to gain new customers. It may also improve the ability of the vendor to monitor the effectiveness of the funds allocated from advertising or marketing budgets.

### Method

In one embodiment, the goods and/or service selection made by a user may be limited to the top three ranked vendors provided upon the user interface.

In another embodiment, a user selecting goods and/or service may have the option to search and select vendors not ranked within the top three upon the user interface.

In one embodiment, the vendor will receive a user request, and may choose to fulfill or deny that request.

In another embodiment, the vendor may elect to allow employees of the vendor to make a determination about if they would like to fulfill or deny a user request. The vendor may allow the employee to fulfill a user request in a capacity other than of an employee of the vendor.

In one embodiment, the vendor will not provide a goods and/or service until payment has been confirmed received from a user. This confirmation may be provided by the distributor or by the vendor themselves.

In one embodiment, the operating module will provide real-time communication of the progression of steps within the method to a user, vendor, distributor, or other entity as would be understood by someone skilled in the art, in order for these parties to be aware of the progression of the provision of goods and/or services. The parties may provide instruction, directions, or other communication to the operating module through the user interface, in order to better enable the facilitation of goods and/or services from the vendor to the user.

In one embodiment, the user may be able to track the progress of the delivery of a goods and/or service upon the user interface.

In one embodiment, the operating module will provide notifications to a user, through the user interface, related to the arrival of goods and/or service at the location of the user.

The invention will now be described with reference to specific examples. It will be understood that the following examples are intended to describe embodiments of the invention and are not intended to limit the invention in any way.

### Example

In one embodiment, a user A 010 will make a request through user interface I1 040 to obtain a good from vendor BB 110. The interface I1 will interact with the operating module OM 060 in order to facilitate the request from user A. The operating module OM will then send a request through user interface I4 080 to vendor BB. This request will be viewed by vendor BB on the user interface I4, and vendor BB decides to accept the request from user A. A vendor BB acceptance notification may be sent through the user interface I4, and the operating module OM, to appear on the user A's interface I1. The user A will send back payment through the interface I1, operating module OM, and user interface I4 to the vendor BB. Once the operating module OP has confirmed transfer of payment from user A, the vendor BB begins the process of providing the good to user A. User A is able to track to progression of the provision of the good from vendor BB through the user interface I4. Information related to parts or the entirety of the transaction between user A and vendor BB will be stored within database DB 070. A user B 020 from the same family, may also access the consumer goods and/or services distribution system through the same user interface I1. User C 030 will also make a request for services from vendor AA 100. The request will be transmitted through the user interface I2 050, onto the operating module OM, the user interface I3 090, until It finally reaches vendor AA. The vendor AA may deny the request of user C through user interface I3 and the operating module OM, to notify user C on interface I2. Information related to parts or the entirety of the transaction between user C and vendor AA will be stored within database DB. The operating module OM may then analyze the information stored within database DB in order to objectively rank the vendors AA and BB, in order to determine if they will appear on the user interfaces I1 or I2.

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure some or all of its components in accordance with the system of the invention.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, personal communication device, server, PDA, or the like and pursuant to one or more, or a part of one or more, program elements, modules or objects generated from any programming language, such as C++, Java, PL/1, .Net, Javascript, Go, Python, Perl Web and Cloud Technologies, or the like. In addition, each step, or a file or object or the like implementing each said step, may be executed by special purpose hardware or a circuit module designed for that purpose.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

The scope of the claims should not be limited by the preferred embodiments set forth in the examples, but should be given the broadest interpretation consistent with the description as a whole.

We claim:

1. A home automation and concierge system comprising:
a home management system operatively connected to one or more devices; wherein the home management system is configured to receive input signals from said one or more devices, generate one or more device commands and transmit the one or more device commands to said one or more devices;
a home concierge system configured to interact with an internet-based concierge service; and
at least one user interface configured to allow a user to operate with the home management system and order from the home concierge system.

2. The system of claim 1, wherein the internet-based concierge service is a cloud-based service.

3. The system of claim 1, wherein the at least one user interface is a tablet.

4. The system of claim 1, wherein the one or more devices are one or more security devices, environmental control devices or entertainment devices.

5. The system of claim 1, wherein the concierge service allows for ordering of products and/or services.

6. The system of claim 1, wherein the concierge system is configured to track order completion.
